(19) United States
(12) Patent Application Publication
(10) Pub. No.: US 2025/0066174 A1
(43) Pub. Date: Feb. 27, 2025

(54) LIFT DEVICE WITH PLATFORM TRAVEL REPLAY

(71) Applicant: Oshkosh Corporation, Oshkosh, WI (US)

(72) Inventors: Taylor Ramsey, Oshkosh, WI (US); Jeff Schaeffer, Oshkosh, WI (US); Matthew Gilbride, Oshkosh, WI (US)

(73) Assignee: Oshkosh Corporation, Oshkosh, WI (US)

(21) Appl. No.: 18/813,402

(22) Filed: Aug. 23, 2024

Related U.S. Application Data
(60) Provisional application No. 63/534,428, filed on Aug. 24, 2023.

(51) Int. Cl. B66F 11/04; B66F 17/00

(52) U.S. Cl. CPC B66F 11/044; B66F 17/006

(57) ABSTRACT

A lift device includes a base assembly, a platform assembly, a lift assembly coupled between the base assembly and the platform assembly and including a lift actuator configured to raise or lower the platform assembly, a rotary motor configured to rotate the platform assembly, and a controller in communication with the drive motor, the lift actuator, and the rotary motor. The controller is configured to record steps performed by the lift actuator and the rotary motor during a positioning event that moves the platform assembly from an initial position to a work site, and operate the lift actuator and the rotary motor to perform the steps performed during the positioning event in a reverse order and in a movement direction that is opposite to a direction of the steps recorded during the positioning event to automate movement of the platform assembly from the work site to the initial position.

### CROSS-REFERENCE TO RELATED PATENT APPLICATIONS

This application claims the benefit of and priority to U.S. Provisional Patent Application No. 63/534,428, filed Aug. 24, 2023, which is incorporated herein by reference in its entirety.

### BACKGROUND

The present disclosure relates to lift devices. More specifically, the present disclosure relates to controlling lift devices.

### SUMMARY

At least one embodiment relates to a lift device. The lift device includes a base assembly having a drive motor, a platform assembly, a lift assembly coupled between the base assembly and the platform assembly and including a lift actuator configured to raise or lower the platform assembly, a rotary motor configured to rotate the platform assembly, and a controller in communication with the drive motor, the lift actuator, and the rotary motor. The controller is configured to record steps performed by the lift actuator and the rotary motor during a positioning event that moves the platform assembly from an initial position to a work site, and operate the lift actuator and the rotary motor to perform the steps performed during the positioning event in a reverse order and in a movement direction that is opposite to a direction of the steps recorded during the positioning event to automate movement of the platform assembly from the work site to the initial position.

At least one embodiment relates to a lift device. The lift device includes a base assembly including a drive motor, a platform assembly, a lift assembly coupled between the base assembly and the platform assembly and including a plurality of actuators configured to move the platform assembly relative to the base assembly, a user interface configured to receive one or more inputs and control operation of the plurality of actuators, and a controller in communication with the plurality of actuators and the user interface. The controller is configured to record steps input to the user interface during a positioning event that moves the platform assembly from an initial position to a work site, wherein each of the steps in the positioning event includes a first direction and a magnitude associated with moving one of the plurality of actuators, and operate the plurality of actuators to perform the steps recorded during the positioning event in a reverse order to automate movement of the platform assembly from the work site to the initial position, wherein each of the steps performed in the reverse order include a second direction, opposite to the first direction, and the magnitude associated with moving the one of the plurality of actuators recorded during the positioning event.

At least one embodiment relates to a method for controlling a platform assembly of a lift device. The method includes recording an input to a user interface during a positioning event that results in movement a platform assembly from an initial position to a work site. The input is recorded as a step that includes moving an actuator or motor in a first direction with a magnitude. The method further includes triggering a travel replay procedure, and in response to triggering the travel replay procedure, performing the step recorded during the positioning event in a reverse order to automate movement of the platform assembly from the work site to the initial position. The step performed in the reverse order includes moving the actuator or motor in a second direction, opposite to the first direction, and the magnitude.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a lift device, according to some embodiments;

FIG. 2 is a perspective view of a base of the lift device of FIG. 1, according to some embodiments;

FIG. 3 is a perspective view of an axle assembly of the lift device of FIG. 1, according to some embodiments;

FIG. 4 is a perspective view of a platform assembly of the lift device of FIG. 1, according to some embodiments;

FIG. 5 is a perspective view of a lift device with a platform assembly positioned at a work site, according to some embodiments;

FIG. 6 is a schematic illustration of a platform assembly of a lift device moving from an initial position to a work site, according to some embodiments;

FIG. 7 is a block diagram of a control system of the lift device of FIG. 1, according to some embodiments; and

FIG. 8 is a flowchart outlining the steps in a method of operating a lift device, according to some embodiments.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overview

In general, a positioning event includes movement of one or more motors and/or actuators that results in placement of a platform at a work site where an operator can perform a job. Positioning events are typically difficult and time consuming for lift devices (e.g., boom lifts), often requiring several individual movements of different components on the lift device to reach a work site. Referring generally to the FIGURES, a lift device includes a control system (e.g., a controller) that is configured to record operations (e.g., movement of a platform, lift arms (tower, boom, jib, etc.), a turntable, and a base (drive motors)) during a positioning event as a platform is moved to a work site. Recording the operations during the positioning event enables the controller to implement a travel replay procedure (e.g., either in response to a request or input). The travel replay procedure may enable the controller to automate the recorded positioning event, either forward or backwards. For example, a positioning event may be recorded (e.g., first step to last step) while a platform is moved from an initial position to a work site.

Upon the platform reaching the work site, the controller is configured to implement the travel replay procedure to perform a reverse of each recorded step in the positioning event in a reverse order (e.g., last step to first step). For example, if a platform is raised in one step during the positioning event, the platform will be lowered the same amount during the travel replay procedure, or if a platform is rotated in a first direction during the positioning event, the platform will be rotated in a second direction, opposite to the first direction, in the travel replay procedure. In this way, for example, the process of returning the platform to the initial position is automated and does not require an operator to perform the complex order of steps that were used to reach the work site. In some embodiments, the replay procedure may automate the platform returning from the initial position to the work site by replaying the steps in the positioning event in a forward order (e.g., first step to last step). In some embodiments, the lift device includes one or more object detection sensors that are configured to override the travel replay procedure if an object is detected within a predefined distance of any portion of the lift device.

### Lift Device

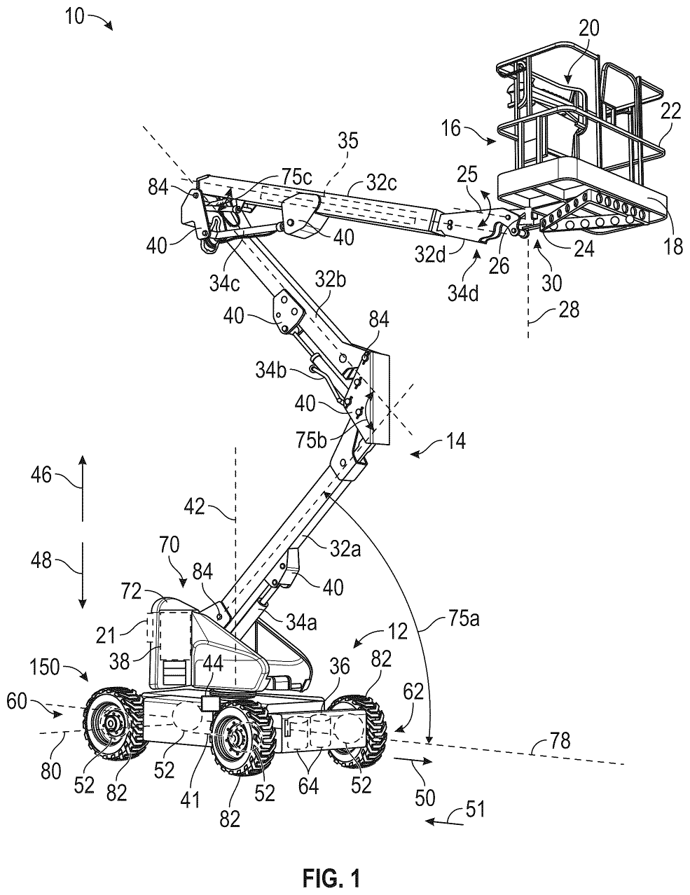

Referring to FIG. 1, a lifting apparatus, lift device, or mobile elevating work platform (MEWP) (e.g., a telehandler, an electric boom lift, a towable boom lift, a lift device, a fully electric boom lift, etc.), shown as lift device 10 includes a base assembly 12 (e.g., a base, a support assembly, a drivable support assembly, a support structure, a chassis, etc.), a platform assembly 16 (e.g., a platform, a terrace, etc.), and a lift assembly 14 (e.g., a boom, a boom lift assembly, a lifting apparatus, an articulated arm, a scissors lift, etc.). The lift device 10 includes a front end (e.g., a forward-facing end, a front portion, a front, etc.), shown as front 62, and a rear end (e.g., a rearward facing end, a back portion, a back, a rear, etc.) shown as rear 60. The lift assembly 14 is configured to elevate the platform assembly 16 in an upward direction 46 (e.g., an upward vertical direction) relative to the base assembly 12. The lift assembly 14 is also configured to translate the platform assembly 16 in a downward direction 48 (e.g., a downward vertical direction). The lift assembly 14 is also configured to translate the platform assembly 16 in either a forward direction 50 (e.g., a forward longitudinal direction) or a rearward direction 51 (e.g., a rearward longitudinal direction). The lift assembly 14 generally facilitates performing a lifting function to raise and lower the platform assembly 16, as well as movement of the platform assembly 16 in various directions.

The base assembly 12 defines a longitudinal axis 78 and a lateral axis 80. The longitudinal axis 78 defines the forward direction 50 of lift device 10 and the rearward direction 51. The lift device 10 is configured to translate in the forward direction 50 and to translate backwards in the rearward direction 51. The base assembly 12 includes one or more wheels, tires, wheel assemblies, tractive elements, rotary elements, treads, etc., shown as tractive elements 82. The tractive elements 82 are configured to rotate to drive (e.g., propel, translate, steer, move, etc.) the lift device 10. The tractive elements 82 can each include an electric motor 52 (e.g., electric wheel motors) configured to drive the tractive elements 82 (e.g., to rotate tractive elements 82 to facilitate motion of the lift device 10). In other embodiments, the tractive elements 82 are configured to receive power (e.g., rotational mechanical energy) from electric motors 52 or through a drive train (e.g., a combination of any number and configuration of a shaft, an axle, a gear reduction, a gear train, a transmission, etc.). In some embodiments, one or more tractive elements 82 are driven by a prime mover 41 (e.g., electric motor, internal combustion engine, etc.) through a transmission. In some embodiments, a hydraulic system (e.g., one or more pumps, hydraulic motors, conduits, valves, etc.) transfers power (e.g., mechanical energy) from one or more electric motors 52 and/or the prime mover 41 to the tractive elements 82. The tractive elements 82 and electric motors 52 (or prime mover 41) can facilitate a driving and/or steering function of the lift device 10. In some embodiments, the electric motors 52 are optional, and the tractive elements 82 are powered or driven by an internal combustion engine.

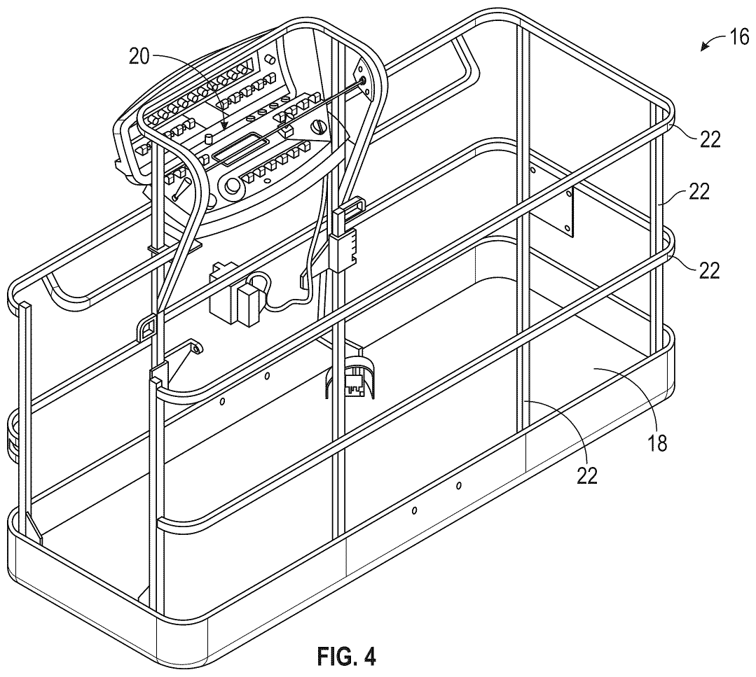

With additional reference to FIG. 4, the platform assembly 16 is shown in further detail. The platform assembly 16 is configured to provide a work area for an operator of the lift device 10 to stand/rest upon. The platform assembly 16 can be pivotally coupled to an upper end of the lift assembly 14. The lift device 10 is configured to facilitate the operator accessing various elevated areas (e.g., lights, platforms, the sides of buildings, building scaffolding, trees, power lines, etc.). The lift device 10 may use various electrically-powered motors and electrically-powered linear actuators or hydraulic cylinders to facilitate elevation and/or horizontal movement (e.g., lateral movement, longitudinal movement) of the platform assembly 16 (e.g., relative to the base assembly 12, or to a ground surface that the base assembly 12 rests upon). In some embodiments, the lift device 10 uses internal combustion engines, hydraulics, a hydraulic system, pneumatic cylinders, etc.

The platform assembly 16 includes a base member, a base portion, a platform, a standing surface, a shelf, a work platform, a floor, a deck, etc., shown as a deck 18. The deck 18 provides a space (e.g., a floor surface) for a worker to stand upon as the platform assembly 16 is raised and lowered.

The platform assembly 16 includes a railing assembly including various members, beams, bars, guard rails, rails, railings, etc., shown as rails 22. The rails 22 extend along substantially an entire perimeter of the deck 18. The rails 22 provide one or more members for the operator of the lift device 10 to grasp while using the lift device 10 (e.g., to grasp while operating the lift device 10 to elevate the platform assembly 16). The rails 22 can include members that are substantially horizontal to the deck 18. The rails 22 can also include vertical structural members that couple with the substantially horizontal members. The vertical structural members can extend upwards from the deck 18.

The platform assembly 16 can include a human machine interface (HMI) (e.g., a user interface, an operator interface, etc.), shown as the user interface 20. The user interface 20 is configured to receive user inputs from the operator at or upon the platform assembly 16 to facilitate operation of the lift device 10. The user interface 20 can include any number of buttons, levers, switches, keys, etc., or any other user input device configured to receive a user input to operate the lift device 10. The user interface 20 may also provide information to the user (e.g., through one or more displays, lights, speakers, haptic feedback devices, etc.). The user interface 20 can be supported by one or more of the rails 22.

Referring to FIG. 1, the platform assembly 16 includes a frame 24 (e.g., structural members, support beams, a body, a structure, etc.) that extends at least partially below the deck 18. The frame 24 can be integrally formed with the deck 18. The frame 24 is configured to provide structural support for the deck 18 of the platform assembly 16. The frame 24 can include any number of structural members (e.g., beams, bars, I-beams, etc.) to support the deck 18. The frame 24 couples the platform assembly 16 with the lift assembly 14. The frame 24 may be rotatably or pivotally coupled with the lift assembly 14 to facilitate rotation of the platform assembly 16 about an axis 28 (e.g., a vertical axis). The frame 24 can also rotatably/pivotally couple with the lift assembly 14 such that the frame 24 and the platform assembly 16 can pivot about an axis 25 (e.g., a horizontal axis).

The lift assembly 14 includes one or more beams, articulated arms, bars, booms, arms, support members, boom sections, cantilever beams, etc., shown as lift arms 32a, 32b, and 32c. The lift arms are hingedly or rotatably coupled with each other at their ends. The lift arms can be hingedly or rotatably coupled to facilitate articulation of the lift assembly 14 and raising/lowering and/or horizontal movement of the platform assembly 16. The lift device 10 includes a lower lift arm 32a, a central or medial lift arm 32b, and an upper lift arm 32c. The lower lift arm 32a is configured to hingedly or rotatably couple at one end with the base assembly 12 to facilitate lifting (e.g., elevation) of the platform assembly 16. The lower lift arm 32a is configured to hingedly or rotatably couple at an opposite end with the medial lift arm 32b. Likewise, the medial lift arm 32b is configured to hingedly or rotatably couple with the upper lift arm 32c. The upper lift arm 32c can be configured to hingedly interface/couple and/or telescope with an intermediate lift arm 32d. The upper lift arm 32c can be referred to as “the jib” of the lift device 10. The intermediate lift arm 32d may extend into an inner volume of the upper lift arm 32c and extend and/or retract. The lower lift arm 32a and the medial lift arm 32b may be referred to as “the boom” of the overall lift device 10 assembly. The intermediate lift arm 32d can be configured to couple (e.g., rotatably, hingedly, etc.), with the platform assembly 16 to facilitate levelling of the platform assembly 16.

The lift arms 32 are driven to hinge or rotate relative to each other by actuators 34a, 34b, 34c, and 34d (e.g., electric linear actuators, linear electric arm actuators, hydraulic cylinders, etc.). The actuators 34a, 34b, 34c, and 34d can be mounted between adjacent lift arms to drive adjacent lift arms to hinge or pivot (e.g., rotate some angular amount) relative to each other about pivot points 84. The actuators 34a, 34b, 34c, and 34d can be mounted between adjacent lift arms using any of a foot bracket, a flange bracket, a clevis bracket, a trunnion bracket, etc. The actuators 34a, 34b, 34c, and 34d may be configured to extend or retract (e.g., increase in overall length, or decrease in overall length) to facilitate pivoting adjacent lift arms to pivot/hinge relative to each other, thereby articulating the lift arms and raising or lowering the platform assembly 16.

The actuators 34a, 34b, 34c, and 34d can be configured to extend (e.g., increase in length) to increase a value of an angle formed between adjacent lift arms 32. The angle can be defined between centerlines of adjacent lift arms 32 (e.g., centerlines that extend substantially through a center of the lift arms 32). For example, the actuator 34a is configured to extend/retract to increase/decrease the angle 75a defined between a centerline of the lower lift arm 32a and the longitudinal axis 78 (angle 75a can also be defined between the centerline of the lower lift arm 32a and a plane defined by the longitudinal axis 78 and lateral axis 80) and facilitate lifting of the platform assembly 16 (e.g., moving the platform assembly 16 at least partially along the upward direction 46). Likewise, the actuator 34b can be configured to retract to decrease the angle 75a to facilitate lowering of the platform assembly 16 (e.g., moving the platform assembly 16 at least partially along the downward direction 48). Similarly, the actuator 34b is configured to extend to increase the angle 75b defined between centerlines of the lower lift arm 32a and the medial lift arm 32b and facilitate elevating of the platform assembly 16. Similarly, the actuator 34b is configured to retract to decrease the angle 75b to facilitate lowering of the platform assembly 16. The electric actuator 34c is similarly configured to extend/retract to increase/decrease the angle 75c, respectively, to raise/lower the platform assembly 16. The actuators 34 may be hydraulic actuators, electric actuators, pneumatic actuators, etc.

The actuators 34a, 34b, 34c, and 34d can be mounted (e.g., rotatably coupled, pivotally coupled, etc.) to adjacent lift arms at mounts 40 (e.g., mounting members, mounting portions, attachment members, attachment portions, etc.). The mounts 40 can be positioned at any position along a length of each lift arm. For example, the mounts 40 can be positioned at a midpoint of each lift arm, and a lower end of each lift arm.

The intermediate lift arm 32d and the frame 24 are configured to pivotally interface/couple at a platform rotator 30 (e.g., a rotary actuator, a rotational electric actuator, a gear box, etc.). The platform rotator 30 facilitates rotation of the platform assembly 16 about the axis 28 relative to the intermediate lift arm 32d. In some embodiments, the platform rotator 30 is positioned between the frame 24 and the upper lift arm 32c and facilitates pivoting of the platform assembly 16 relative to the upper lift arm 32c. The axis 28 extends through a central pivot point of the platform rotator 30. The intermediate lift arm 32d can also be configured to articulate or bend such that a distal portion of the intermediate lift arm 32d pivots/rotates about the axis 25. The intermediate lift arm 32d can be driven to rotate/pivot about axis 25 by extension and retraction of the actuator 34d.

The intermediate lift arm 32d is also configured to extend/retract (e.g., telescope) along the upper lift arm 32c. In some embodiments, the lift assembly 14 includes a linear actuator (e.g., a hydraulic cylinder, an electric linear actuator, etc.), shown as extension actuator 35, that controls extension and retraction of the intermediate lift arm 32d relative to the upper lift arm 32c. In other embodiments, one more of the other arms of the lift assembly 14 include multiple telescoping sections that are configured to extend/retract relative to one another.

The platform assembly 16 is configured to be driven to pivot about the axis 28 (e.g., rotate about axis 28 in either a clockwise or a counter-clockwise direction) by an electric or hydraulic motor 26 (e.g., a rotary electric actuator, a stepper motor, a platform rotator, a platform electric motor, an electric platform rotator motor, etc.). The motor 26 (e.g., the pivot motor 26) can be configured to drive the frame 24 to pivot about the axis 28 relative to the upper lift arm 32c (or relative to the intermediate lift arm 32d). The motor 26 can be configured to drive a gear train to pivot the platform assembly 16 about the axis 28.

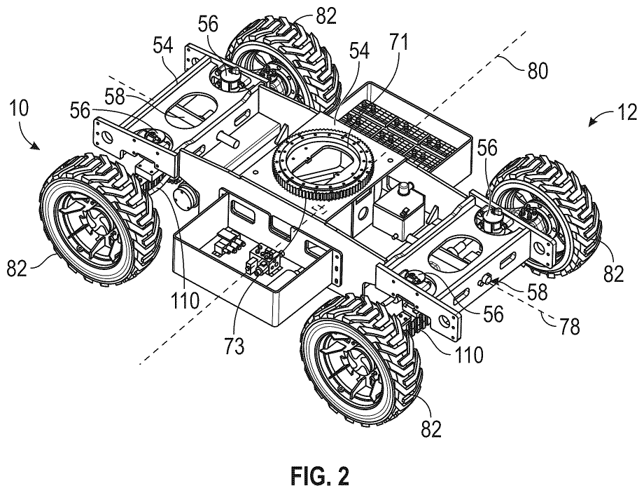

Referring to FIGS. 1 and 2, the lift assembly 14 is configured to pivotally or rotatably couple with the base assembly 12. The base assembly 12 includes a rotatable base member, a rotatable platform member, a fully electric turntable, etc., shown as a turntable 70. The lift assembly 14 is configured to rotatably/pivotally couple with the base assembly 12. The turntable 70 is rotatably coupled with a base, frame, structural support member, carriage, etc., of base assembly 12, shown as base 36. The turntable 70 is configured to rotate or pivot relative to the base 36. The turntable 70 can pivot/rotate about the central axis 42 relative to base 36, about a slew bearing 71 (e.g., the slew bearing 71 pivotally couples the turntable 70 to the base 36). The turntable 70 facilitates accessing various elevated and angularly offset locations at the platform assembly 16. The turntable 70 is configured to be driven to rotate or pivot relative to base 36 and about the slew bearing 71 by an electric motor, an electric turntable motor, an electric rotary actuator, a hydraulic motor, etc., shown as the turntable motor 44. The turntable motor 44 can be configured to drive a geared outer surface 73 of the slew bearing 71 that is rotatably coupled to the base 36 about the slew bearing 71 to rotate the turntable 70 relative to the base 36. The lower lift arm 32a is pivotally coupled with the turntable 70 (or with a turntable member 72 of the turntable 70) such that the lift assembly 14 and the platform assembly 16 rotate as the turntable 70 rotates about the central axis 42. In some embodiments, the turntable 70 is configured to rotate a complete 360 degrees about the central axis 42 relative to the base 36. In other embodiments, the turntable 70 is configured to rotate an angular amount less than 360 degrees about the central axis 42 relative to the base 36 (e.g., 270 degrees, 120 degrees, etc.).

The base assembly 12 includes one or more energy storage devices or power sources (e.g., capacitors, batteries, Lithium-Ion batteries, Nickel Cadmium batteries, fuel tanks, etc.), shown as batteries 64. The batteries 64 are configured to store energy in a form (e.g., in the form of chemical energy) that can be converted into electrical energy for the various electric motors and actuators of the lift device 10. The batteries 64 can be stored within the base 36. The lift device 10 includes a controller 38 that is configured to operate any of the motors, actuators, etc., of the lift device 10. The controller 38 can be configured to receive sensory input information from various sensors of the lift device 10, user inputs from the user interface 20 (or any other user input device such as a key-start or a push-button start), etc. The controller 38 can be configured to generate control signals for the various motors, actuators, etc., of the lift device 10 to operate any of the motors, actuators, electrically powered movers, etc., of the lift device 10. The batteries 64 are configured to power any of the motors, sensors, actuators, electric linear actuators, electrical devices, electrical movers, stepper motors, etc., of the lift device 10. The base assembly 12 can include a power circuit including any necessary transformers, resistors, transistors, thermistors, capacitors, etc., to provide appropriate power (e.g., electrical energy with appropriate current and/or appropriate voltage) to any of the motors, electric actuators, sensors, electrical devices, etc., of the lift device 10.

The batteries 64 are configured to deliver power to the motors 52 to drive the tractive elements 82. A rear set of tractive elements 82 can be configured to pivot to steer the lift device 10. In other embodiments, a front set of tractive elements 82 are configured to pivot to steer the lift device 10. In still other embodiments, both the front and the rear set of tractive elements 82 are configured to pivot (e.g., independently) to steer the lift device 10. In some examples, the base assembly 12 includes a steering system 150. The steering system 150 is configured to drive tractive elements 82 to pivot for a turn of the lift device 10. The steering system 150 can be configured to pivot the tractive elements 82 in pairs (e.g., to pivot a front pair of tractive elements 82), or can be configured to pivot tractive elements 82 independently (e.g., four-wheel steering for tight-turns).

It should be understood that while the lift device 10 as described herein is described with reference to batteries, electric motors, etc., the lift device 10 can be powered (e.g., for transportation and/or lifting the platform assembly 16) using one or more internal combustion engines, electric motors or actuators, hydraulic motors or actuators, pneumatic actuators, or any combination thereof.

In some embodiments, the base assembly 12 also includes a user interface 21 (e.g., a HMI, a user interface, a user input device, a display screen, etc.). In some embodiments, the user interface 21 is coupled to the base 36. In other embodiments, the user interface 21 is positioned on the turntable 70. The user interface 21 can be positioned on any side or surface of the base assembly 12 (e.g., on the front 62 of the base 36, on the rear 60 of the base 36, etc.).

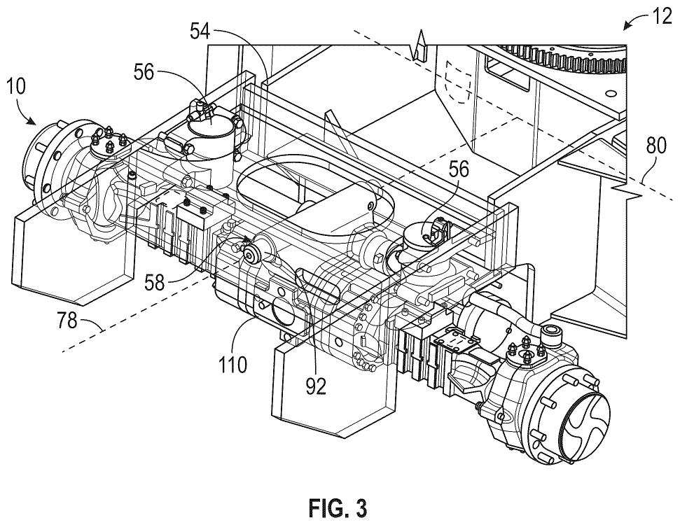

Referring now to FIGS. 2 and 3, the base assembly 12 includes a longitudinally extending frame member 54 (e.g., a rigid member, a structural support member, an axle, a base, a frame, a carriage, a chassis, etc.). The longitudinally extending frame member 54 provides structural support for the turntable 70 as well as the tractive elements 82. The longitudinally extending frame member 54 is pivotally coupled with lateral frame members 110 (e.g., axles, frame members, beams, bars, etc.) at opposite longitudinal ends of the longitudinally extending frame member 54. For example, the lateral frame members 110 may be pivotally coupled with the longitudinally extending frame member 54 at a front end and a rear end of the longitudinally extending frame member 54. The lateral frame members 110 can each be configured to pivot about a pivot joint 58 (e.g., about a longitudinal axis). The pivot joint 58 can include a pin and a receiving portion (e.g., a bore, an aperture, etc.). The pin of the pivot joint 58 is coupled to one of the lateral frame members 110 (e.g., a front lateral frame member 110 or a rear lateral frame member 110) or the longitudinally extending frame member 54 and the receiving portion is coupled to the other of the longitudinally extending frame member 54 and the lateral frame member 110. For example, the pin may be coupled with longitudinally extending frame member 54 and the receiving portion can be coupled with one of the lateral frame members 110 (e.g., integrally formed with the front lateral frame member 110).

In some embodiments, the longitudinally extending frame member 54 and the lateral frame members 110 are integrally formed or coupled (e.g., fastened, welded, riveted, etc.) to define the base 36. In still other embodiments, the base 36 is integrally formed with the longitudinally extending frame member 54 and/or the lateral frame members 110. In still other embodiments, the base 36 is coupled with the longitudinally extending frame member 54 and/or the lateral frame members 110.

The base assembly 12 includes one or more axle actuators 56 (e.g., electric linear actuators, electric axle actuators, electric levelling actuators, hydraulic cylinders, etc.). The axle actuators 56 can be linear actuators configured to receive power from the batteries 64, for example. The axle actuators 56 can be configured to extend or retract to contact a top surface of a corresponding one of the lateral frame members 110. When the axle actuators 56 extend, an end of a rod of the levelling actuators can contact the surface of lateral frame member 110 and prevent relative rotation between lateral frame member 110 and longitudinally extending frame member 54. In this way, the relative rotation/pivoting between the lateral frame member 110 and the longitudinally extending frame member 54 can be locked (e.g., to prevent rolling of the longitudinally extending frame member 54 relative to the lateral frame members 110 during operation of the lift assembly 14). The axle actuators 56 can receive power from the batteries 64, which can allow the axle actuators 56 to extend or retract. The axle actuators 56 receive control signals from controller 38.

### Platform Travel Replay

During operation of the lift device 10, the platform assembly 16 may be moved to various locations so that an operator can perform a job at a work site. Moving the platform assembly 16 from an initial position to a work site (e.g., a positioning event) may be facilitated by one or more of the pivot motor 26, the platform rotator 30, the actuators 34a, 34b, 34c, 34d, the extension actuator 35, the turntable motor 44, and/or the electric motors 42. In general, an operator may interface with the user interface 20 to control operation of the pivot motor 26, the platform rotator 30, the actuators 34a, 34b, 34c, 34d, the extension actuator 35, the turntable motor 44, and/or the electric motors 42, which results in movement of the platform assembly 16.

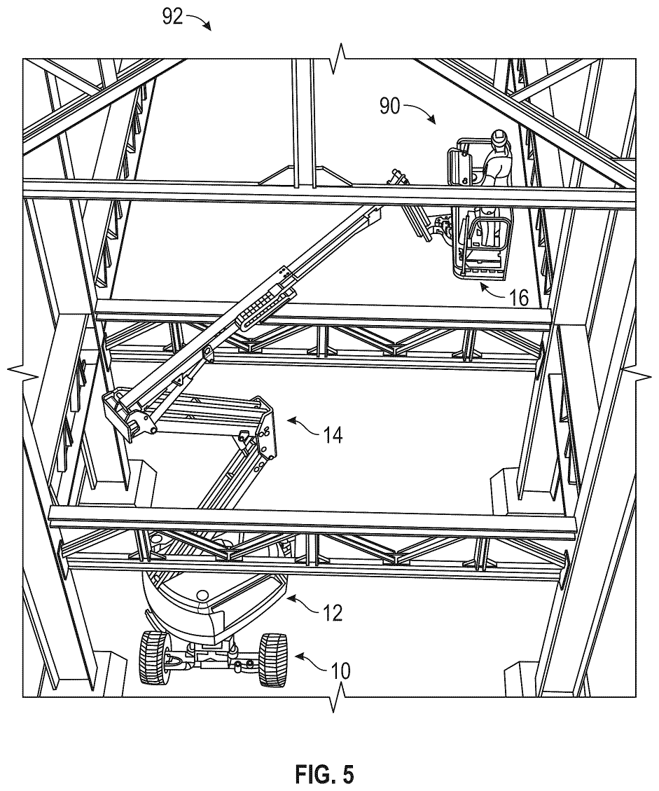

FIG. 5 shows an example of the lift device 10 with the platform assembly 16 at a work site 90 amongst a steel structure or building frame 92. In general, moving the platform assembly 16 from an initial position to a work site can be a difficult and time consuming process for an operator to perform manually. For example, a positioning event may include two or more steps, or three or more steps, or five or more steps, or ten or more steps that are input to the user interface 20 and perform the individual movements of the platform assembly 16 that result in travel to a work site 90.

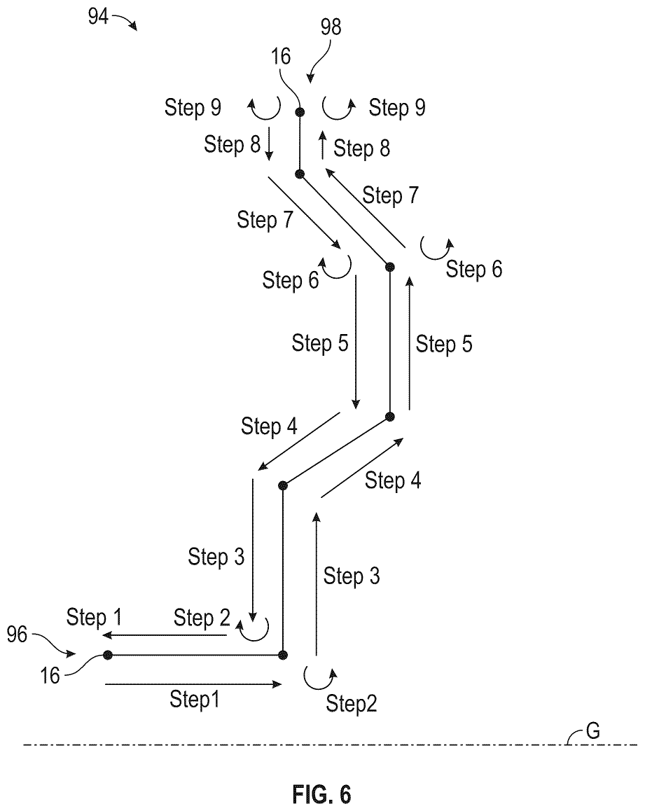

FIG. 6 schematically illustrates a positioning event 94 for the platform assembly 16, where the platform assembly 16 is moved from an initial position 96 to a work site 98 (e.g., the work site 90 within the building frame 92). In general, the platform assembly 16 is moved relative to a ground plane G, for example, by an operator interfacing with the user interface 20 or in an automated fashioned by a control system or controller as described herein. In some embodiments, the positioning event 94 may initiate, at step 1, with the platform assembly 16 being driven to a pre-lift position by the electric motors 52 driving the tractive elements 82, which moves the base assembly 12, and the platform assembly 16 coupled thereto, in a predefined direction (e.g., a first drive direction, the forward direction 50, or the rearward direction 51). At step 2, the turntable motor 44 may rotate the turntable 70 and the platform assembly 16 coupled thereto (e.g., in a first rotation direction). Once the platform assembly 16 is rotated at step 2, the platform assembly 16 is lifted (e.g., in a first lift direction or the upward direction 46), at step 3, by one or more of the actuators 34a, 34b, 34c, 34d. With the platform assembly 16 lifted, the extension actuator 35 may extend the platform assembly 16 at step 4 and the platform assembly 16 may be lifted again by one or more of the actuators 34a, 34b, 34c, 34d at step 5. The turntable motor 44 may again rotate the turntable 70 and the platform assembly 16 coupled thereto at step 6, and the extension actuator 35 may further extend the platform assembly 16 at step 7. One or more of the actuators 34a, 34b, 34c, 34d may again lift the platform assembly at step 8, and the platform assembly 16 may be rotated by the platform rotator 30 or pivoted by the pivot motor 26 at step 9 to reach the work site 98. It should be appreciated that although the exemplary positioning event 94 in FIG. 6 includes nine steps, the systems and methods of the present disclosure are applicable to positioning events with more or fewer than nine steps and that include any order or number of positional movements of the platform assembly 16.

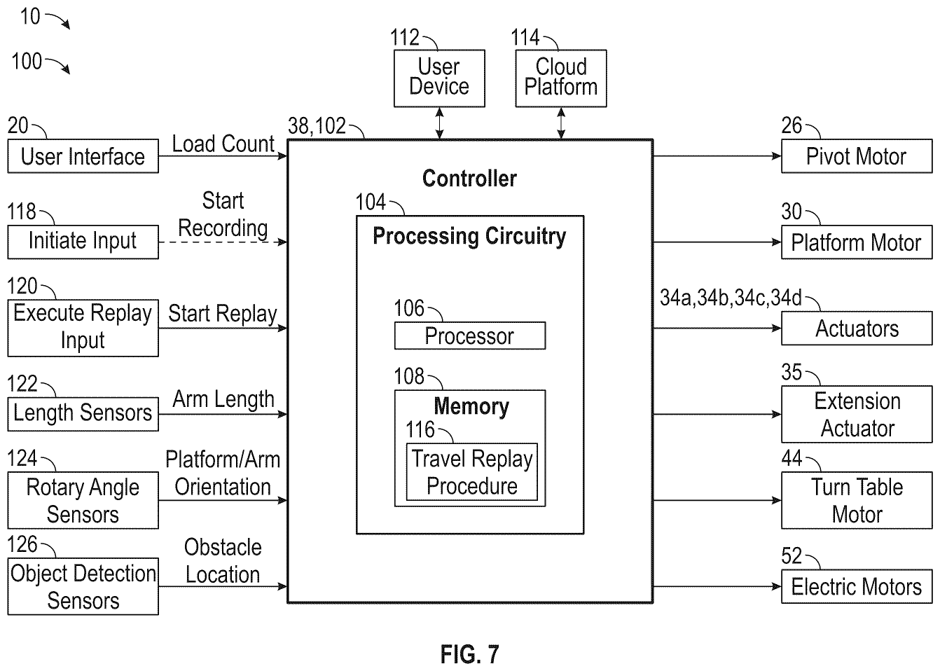

Referring to FIG. 7, the lift device 10 includes a control system 100 that includes a controller 102 (e.g., the controller 38). The controller 102 includes a processing circuitry 104, a processor 106, and a memory 108. Processing circuitry 104 can be communicably connected to a communications interface such that the processing circuitry 104 and the various components thereof can send and receive data via the communications interface. The processor 106 can be implemented as a general purpose processor, an application specific integrated circuit (ASIC), one or more field programmable gate arrays (FPGAs), a group of processing components, or other suitable electronic processing components.

The memory 108 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. The memory 108 can be or include volatile memory or non-volatile memory. The memory 108 can include database components, object code components, script components, or any other type of information structure for supporting the various activities and information structures described in the present application. According to some embodiments, the memory 108 is communicably connected to the processor 106 via the processing circuitry 104 and includes computer code for executing (e.g., by the processing circuitry 104 and/or the processor 106) one or more processes described herein.

In some embodiments, the controller 102 is implemented within a single computer (e.g., one server, one housing, etc.). In various other embodiments, the controller 102 can be distributed across multiple servers or computers (e.g., that can exist in distributed locations).

In the illustrated embodiment, the controller 102 is in communication with the user interface 20, the pivot motor 26, the platform rotator 30, the actuators 34a, 34b, 34c, 34d, the extension actuator 35, the turntable motor 44, the electric motors 42, and one or more object detection sensors 126. In some embodiments, the controller 102 is in communication with a user device 112 (e.g., a cell phone, a tablet, a computer, etc.). In some embodiments, the controller 102 is in communication with a cloud platform 114, for example, via a wireless connection. In the illustrated embodiment, the memory 108 stores instructions for a travel replay procedure 116.

In some embodiments, the controller 102 is in communication with an initiate input 118 that is configured to trigger the controller 102 to initiate a recording process in the travel replay procedure 116. In some embodiments, the initiate input 118 is on the user interface 20 in the form of a button, a switch, a graphical button, or a soft key on a display. In some embodiments, the initiate input 118 is in the form of a button or a switch arranged on the platform assembly 16 in a location remote from the user interface 20, which separates the travel replay procedure 116 from the standard operational controls on the user interface 20. In some embodiments, the initiate input 118 is in the form of a graphical button, a digital button, or soft key on the user device 112.

In some embodiments, the controller 102 is in communication with a replay execute input 120 that is configured to execute a forward replay or a reverse replay of the travel replay procedure 116. In some embodiments, the replay execute input 120 is on the user interface 20 in the form of reverse/forward buttons, reverse/forward switches, reverse/forward graphical/digital buttons, or reverse/forward soft keys on a display. In some embodiments, the initiate input 118 is in the form of reverse/forward buttons or reverse/forward switches arranged on the platform assembly 16 in a location remote from the user interface 20, which separates the replay execute input 120 from the standard operational controls on the user interface 20. In some embodiments, the replay execute input 120 is in the form of reverse/forward soft keys on the user device 112.

In some embodiments, the controller 102 is in communication with one or more length sensors 122, one or more rotary angle sensors 124, and one or more object detection sensors 126. The one or more length sensors 122 may be in the form of ultrasonic, optical (e.g., laser, LIDAR, etc.), or hall effect sensors that are configured to detect an extension or retraction length of each of the lift arms 32a, 32b, 32c, 32d and/or extension or retraction length of each of the actuators 34a, 34b, 34c, 34d and the extension actuator 35. The one or more rotary angle sensors 124 may be in the form of rotary encoders or a rotary limit switch that measures, for example, the angles 75a, 75b, 75c, the rotation about the axis 28, and/or the pivot about the axis 25. The object detection sensors 126 may be in the form of radar sensors, scanning laser sensors, light detection and ranging (LIDAR) sensors, and image processing sensors, such as cameras. The object detection sensors 126 may be mounted to the base assembly 12, the lift arms 32a, 32b, 32c, 32d, and/or the platform assembly 16. In general, the object detection sensors 126 are configured to detect objects adjacent to the base assembly 12, the lift arms 32a, 32b, 32c, 32d, and/or the platform assembly 16. In response to the object detection sensors 126 detecting an object within a predefined vicinity (e.g., within a predetermined distance) of the base assembly 12, the lift arms 32a, 32b, 32c, 32d, and/or the platform assembly 16, the controller 102 is configured to cease or override the travel replay procedure 116. For example, the object detection sensors 126 are configured to detect if an object or obstruction is present along the travel path of the platform assembly 16. With several components of the lift device 10 potentially moving as the platform assembly 16 travels to/from a work site, the object detection sensors 126 may be arranged on each moving component of the lift device 10 and define a field of view that encompasses the entire range of motion defined by each component.

In general, the controller 102 is configured to record the individual steps during a positioning event, for example, in response to receiving an initiate signal from the initiate input 118 (e.g., a user interfacing or engaging with the initiate input 118), or in response to the controller 102 or the cloud platform 114 automatically identifying that a positioning event is occurring based on previously stored data that is stored in the cloud platform 114 and analyzed using a machine learning algorithm. The travel replay procedure 116 may enable the controller 102 to automate the recorded positioning event, either in the order it was recorded (e.g., forward) or in reverse, to move the platform assembly 16 without operator interaction.

In some embodiments, in response to receiving the initiate signal (e.g., start recording) from the initiate input 118 (e.g., when the platform assembly 16 is at an initial position), the controller 102 begins to record each of the inputs (e.g., steps) to the user interface 20 that result in a movement of the platform assembly 16 (e.g., a positioning event). For example, the controller 102 may record a plurality of input steps that are applied by an operator to the user interface 20, with each of the input steps resulting in movement of the platform assembly 16 by at least one of the plurality of actuators/motors on the lift device 10 (e.g., the pivot motor 26, the platform rotator 30, the actuators 34a, 34b, 34c, 34d, the extension actuator 35, the turntable motor 44, and/or the electric motors 42). The controller 102 may record a direction and magnitude (e.g., an extension/retraction distance, degrees of rotation, etc.) for each of the input steps performed during the positioning event. In some embodiments, the controller 102 and/or the cloud platform 114 may record the input steps that are applied by the user device 112, and the user device 112 may be used to remotely control operation of the lift device 10 and the platform assembly 16. In some embodiments, an operator engages the initiate input 118 to output the initiate signal to the controller 102 that triggers the travel replay procedure 116 to begin recording the steps in a positioning event, and engages the initiate input 118 again to output a stop signal to the controller 102 that triggers the controller 102 to stop recording the steps in the positioning event (e.g., at a work site). In some embodiments, the controller 102 stops recording the steps in a position event in response to the platform assembly 16 being stationary for a predefined amount of time (e.g., at a work site).

Once the controller 102 records the steps in a positioning event, the execute replay input 120 may be activated based on the current position of the platform assembly 16. That is, if the controller 102 detects that a positioning event finished recording (e.g., either via the subsequent engagement of the initiate input 118 or the platform assembly 16 being stationary for the predefined amount of time), the controller 102 may inhibit the forward replay functionality of the execute replay input 120 in the travel replay procedure 116. That is, once a position event is recorded by the controller 102, the controller 102 only allows the reverse replay to occur in the travel replay procedure 116. In other words, the execute replay input 120 is only allowed to output an execute reverse replay signal to the controller 102 after initially recording the steps in the positioning event, and is prevented from outputting an execute forward replay signal to the controller 102.

During the reverse replay of the travel replay procedure 116 (e.g., in response to receiving the execute reverse replay signal from the execute replay input 120), the controller 102 is configured to repeat each step in the recorded positioning event in a reverse order in which the events were recorded and with a movement direction and magnitude that is opposite to the direction in which the step was recorded. For example, with reference to the exemplary positioning event in FIG. 6, the platform assembly 16 may be moved at step 1 (e.g., via the actuators 34a, 34b, 34c, 34d, the extension actuator 35, or the electric motors 52) in a first direction. The amount that the platform assembly 16 moves during step 1 may be measured by one or more of the sensors (e.g., the length sensors 122 and/or the rotary sensors 124). The platform assembly 16 may then be rotated/pivoted (e.g., via the pivot motor 26, the platform rotator 30, or the turntable motor 44) in a first rotation/pivoting direction at step 2. The rotary/pivotal movement of the platform assembly 16 during step 2 may be measured by the rotary angle sensors 124.

In an exemplary embodiment where steps 1 and 2 conclude the positioning event, the reverse replay of the travel replay procedure 116 is configured to initially perform recorded step 2 with the platform assembly 16 rotating/pivoting an amount that is the same that was measured when step 2 was recorded and in a second rotation/pivoting direction opposite to the first rotation/pivoting direction. Then perform recorded step 1 with the platform assembly 16 moving in an amount that is the same that was measured when step 1 was recorded and in a second direction opposite to the first direction. In an exemplary embodiment where a positioning event includes steps 1-9 of FIG. 6, the reverse replay of the travel replay procedure 116 would perform step 9 through step 1 in reverse order (e.g., recorded in 1 through 9 and replayed in reverse, 9 through 1). With the magnitude of the movements being the same as they were recorded and in an opposite direction to which they were recorded.

Once the travel replay procedure 116 completes the reverse replay, the platform assembly 16 is returned, without operator input, to the initial position where the travel replay procedure 116 was instructed to begin recording. The forward replay of the travel replay procedure 116 may be enabled once the reverse replay of the travel replay procedure 116 is completed. That is, the execute replay input 120 is allowed to output the execute forward replay signal to the controller 102, and prevented from outputting the execute reverse replay signal. The forward replay of the travel replay procedure 116 is configured to perform the steps of the positioning event in the same order in which they were recorded. For example, if steps 1 and 2 represent a positioning event, steps 1 and 2 may be replayed in the same order and in the same movement direction that they were recorded, which moves the platform assembly 16 from the initial position to the work site without operator input.

If at any point during the travel replay procedure 116 (e.g., either the forward replay or the reverse replay) the object detection sensors 126 detect an object within a predefined range or distance of the base assembly 12, the lift arms 32a, 32b, 32c, 32d, and/or the platform assembly 16, the controller 102 is configured to stop movement of the platform assembly 16 and overrides the travel replay procedure 116. In some embodiments, the controller 102 is configured to provide an indication on the user interface 20 or the user device 112 upon detecting an object with one of the object detection sensors 126, and an operator is required to address the indication prior to the travel replay procedure 116 being activated or reenabled. In some embodiments, the controller 102 may be configured to receive an initial or first indication that an object is detected by one or more of the object detection sensors 126 and then take read a subsequent or second measurement, at a predetermined time interval after the first indication, from the same of the one or more object detection sensors 126 to determine if the detected object is moving closer to (e.g., in the travel path) or further away from the corresponding object detection sensor(s) 126. If the second measurement is less than the value at the first indication, then the controller 102 may cease or override the travel replay procedure 116 and stop movement of the lift device 10. In some embodiments, when the controller 102 overrides the travel replay procedure 116, the travel replay procedure 116 becomes inactive and the memory 108 is cleared of the previously-recorded steps in a positioning event. As such, the travel replay procedure 116 is not reactivated until a new positioning event is recorded.

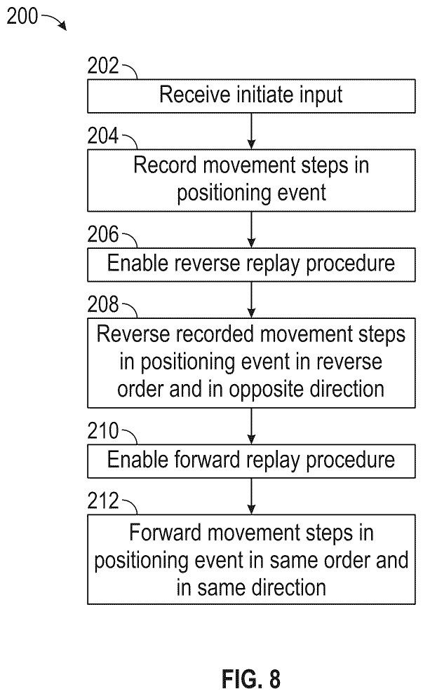

FIG. 8 shows a method 200 for controlling a platform assembly (e.g., the platform assembly 16) of a lift device (e.g., the lift device 10) and performing the travel replay procedure. In some embodiments, the steps in the method 200 are carried out by the controller 102 or another controller in communication with the controller 102 (e.g., the cloud platform 114). The method 200 begins at step 202 by receiving an initiate input (e.g., the initiate input 118). Once the initiate input is received at step 202, a travel replay procedure (e.g., the travel replay procedure 116) records each step during a positioning event at step 204. In some embodiments, each step in a positioning event imparts movement on the platform assembly 16, and each movement (e.g., direction and magnitude) is recorded at step 204. After each step is recorded at step 204 (e.g., the platform assembly 16 has reached a work site), a reverse replay procedure of the travel replay procedure may be enabled at step 206. In some embodiments, the reverse replay is not enabled if a weight (e.g., as measured by a weight sensor) on the platform assembly 16 has increased or decreased a predefine amount from a value that was measured at the end of the positioning event.

In response to the reverse replay procedure being enabled at step 206, the recorded steps in the positioning event may be carried out in a reverse order and in an opposite direction in which they were recorded at step 208. In other words, the platform assembly 16 is moved from the work site to an initial position by following the recorded steps in a reverse order and in an opposite movement direction.

For example, in the exemplary positioning event of FIG. 6, the controller 102 may be instructed to record steps 1-9 in the positioning event 94 and, in response to an instruction to carry out a reverse replay of the travel replay procedure 116, the controller 102 may provide instructions to one or more of the pivot motor 26, the platform rotator 30, the actuators 34a, 34b, 34c, 34d, the extension actuator 35, the turntable motor 44, and/or the electric motors 42 to automate the reverse of the positioning event 94 to move the platform assembly back to the initial position 96 by performing step 9 to step 1 (i.e., reverse order) with an opposite movement direction. For example, step 9 may be performed first in the reverse replay by rotating/pivoting the platform assembly 16 in a direction opposite to the rotation/pivoting direction that was recorded during the positioning event. Then step 8 may be performed with one or more of the actuators 34a, 34b, 34c, 34d lowering the lift platform 16 (e.g., in the downward direction 48, and then step 7 may be performed with the extension actuator 35 retracting the platform assembly 16, and so on until step 1 is performed in an opposite direction than it was recorded. This brings the platform assembly 16 from the work site to the initial position without the operator input.

With the reverse replay procedure completed at step 208, the forward replay of the travel replay procedure may be enabled at step 210. Once the forward replay is enabled at step 210, the forward steps (i.e., the same steps that were recorded during the positioning event) may be performed to again move the platform assembly 16 from the initial position to the work site, without operator input.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure.

It is important to note that the construction and arrangement of the lift device 10 and control system 100 as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A lift device comprising:
a base assembly including a drive motor;
a platform assembly;
a lift assembly coupled between the base assembly and the platform assembly and including a lift actuator configured to raise or lower the platform assembly;
a rotary motor configured to rotate the platform assembly; and
a controller in communication with the drive motor, the lift actuator, and the rotary motor, the controller being configured to:
record steps performed by the lift actuator and the rotary motor during a positioning event that moves the platform assembly from an initial position to a work site; and
operate the lift actuator and the rotary motor to perform the steps performed during the positioning event in a reverse order and in a movement direction that is opposite to a direction of the steps recorded during the positioning event to automate movement of the platform assembly from the work site to the initial position.

2. The lift device of claim 1, wherein the controller is configured to, after operating the lift actuator and the rotary motor to perform the steps in the reverse order, operate the lift actuator and the rotary motor in a forward order to automate movement of the platform assembly from the initial position back to the work site.

3. The lift device of claim 1, further comprising an initiate input in communication with the controller, wherein the controller is configured to begin to record the steps performed in the positioning event in response to receiving an initiate signal from the initiate input.

4. The lift device of claim 3, wherein the controller is configured to stop recording the steps performed in the positioning event in response to receiving a stop signal from the initiate input.

5. The lift device of claim 3, wherein the controller is configured to stop recording the steps performed in the positioning event in response to the platform assembly being stationary for a predefined amount of time.

6. The lift device of claim 1, further comprising a execute replay input, wherein the controller is configured operate the lift actuator and the rotary motor to perform the steps performed during the positioning event in the reverse order in response to receiving an execute reverse replay signal from the execute replay input.

7. The lift device of claim 6, wherein the execute replay input is prevented from outputting an execute forward replay signal after the controller initially records the steps in the positioning event.

8. The lift device of claim 7, wherein the after operating the lift actuator and the rotary motor to perform the steps in the reverse order, the controller is configured to receive the execute forward replay signal from the execute replay input and operate the lift actuator and the rotary motor in a forward order to automate movement of the platform assembly from the initial position back to the work site.

9. The lift device of claim 1, further comprising an object detection sensor coupled to the platform assembly or the lift assembly, wherein the controller is in communication with the object detection sensor and configured to stop operation of the lift actuator and the rotary motor in response to detecting an object.

10. A lift device comprising:
a base assembly including a drive motor;
a platform assembly;
a lift assembly coupled between the base assembly and the platform assembly and including a plurality of actuators configured to move the platform assembly relative to the base assembly;
a user interface configured to receive one or more inputs and control operation of the plurality of actuators; and
a controller in communication with the plurality of actuators and the user interface, the controller being configured to:
record steps input to the user interface during a positioning event that moves the platform assembly from an initial position to a work site, wherein each of the steps in the positioning event includes a first direction and a magnitude associated with moving one of the plurality of actuators; and
operate the plurality of actuators to perform the steps recorded during the positioning event in a reverse order to automate movement of the platform assembly from the work site to the initial position, wherein each of the steps performed in the reverse order include a second direction, opposite to the first direction, and the magnitude associated with moving the one of the plurality of actuators recorded during the positioning event.

11. The lift device of claim 10, further comprising an initiate input in communication with the controller, wherein the controller is configured to begin to record the steps performed in the positioning event in response to receiving an initiate signal from the initiate input.

12. The lift device of claim 11, wherein the controller is configured to stop recording the steps performed in the positioning event in response to receiving a stop signal from the initiate input.

13. The lift device of claim 11, wherein the controller is configured to stop recording the steps performed in the positioning event in response to the platform assembly being stationary for a predefined amount of time.

14. The lift device of claim 10, further comprising a execute replay input, wherein the controller is configured operate the plurality of actuators to perform the steps recorded during the positioning event in the reverse order in response to receiving an execute reverse replay signal from the execute replay input.

15. The lift device of claim 14, wherein the execute replay input is prevented from outputting an execute forward replay signal after the controller initially records the steps in the positioning event.

16. The lift device of claim 15, wherein the after operating the plurality of actuators to perform the steps recorded during the positioning event in the reverse order, the controller is configured to receive the execute forward replay signal from the execute replay input and operate the steps of the positioning event in a forward order to automate movement of the platform assembly from the initial position back to the work site.

17. The lift device of claim 10, further comprising an object detection sensor coupled to the platform assembly or the lift assembly, wherein the controller is in communication with the object detection sensor and configured to stop operation of the plurality of actuators in response to detecting an object.

18. The lift device of claim 10, wherein the controller is configured to, after operating the plurality of actuators to perform the steps recorded during the positioning event in the reverse order, operate the plurality of actuators in a forward order to automate movement of the platform assembly from the initial position back to the work site.

19. A method for controlling a platform assembly of a lift device, the method comprising:
recording an input to a user interface during a positioning event that results in movement a platform assembly from an initial position to a work site, wherein the input is recorded as a step that includes moving an actuator or motor in a first direction with a magnitude; and
triggering a travel replay procedure; and
in response to triggering the travel replay procedure, performing the step recorded during the positioning event in a reverse order to automate movement of the platform assembly from the work site to the initial position, wherein the step performed in the reverse order includes moving the actuator or motor in a second direction, opposite to the first direction, and the magnitude.

20. The method of claim 19, further comprising:
stopping operation of the actuator or motor in response to detecting an object in a path of the platform assembly.
